(19) United States
(12) Patent Application Publication
(10) Pub. No.: US 2015/0203800 A1
(43) Pub. Date: Jul. 23, 2015

(54) MODULAR KEG FOR HOME BREWING

(71) Applicant: Northern Brewer LLC, Roseville, MN (US)

(72) Inventor: John Thomas Hansmann, Minneapolis, MN (US)

(21) Appl. No.: 14/161,090

(22) Filed: Jan. 22, 2014

(51) Int. Cl. C12C 13/10

(52) U.S. Cl. CPC C12C 13/10

(57) ABSTRACT

A home beer brewing and dispensing apparatus includes: interchangeable keg bodies of different volumes; a keg top, with pipe connectors, fastened to a top section of a keg body using an air-tight top gasket and a clamp; and a keg bottom fastened to a bottom section of the keg body using an air-tight bottom gasket and a clamp.

### FIELD OF THE INVENTION

The present invention relates generally to a home beer brewing apparatus for brewing, storing and dispensing beer and wort, and more specifically to a home beer brewing apparatus having modular components to offer various keg size interchangeability for home brewers.

### BACKGROUND

Conventional home beer brewing equipment typically includes: a kettle and an adjacent burner kit; chillers, a fermenter, carboy or other container; a bottling bucket, and cleaners, sanitizers, brushes and other cleaning equipment; tubing for siphoning and bottling; beer bottles, caps and a bottle capper; malted barley or extracts or other cereal grains; hops, yeast and other accessories and ingredients dependent on the specific beer recipe. A keg may also be used for carbonating and storing beer under pressure for dispensing.

A Cornelius keg (also known as a corney or soda keg) is a metal container such as a stainless steel cylinder originally used by the soft drink industry that can be used to store and dispense homemade sodas and home brewed beer. A Cornelius keg can typically hold liquid at a maximum pressure of 130 psi. There are typically three openings in the Cornelius keg: a large central hole which, by its design, can only be opened when the keg is not pressurized, and two smaller ports with valves which are only opened when a hose with an appropriate fitting is attached to them. The central opening is used for filling and cleaning the keg, while the two ports are used to dispense the drink. On the lid for the central opening, there is a metal handle that when depressed, closes and seals the keg. Also on the top is a pressure relief valve that is usually identified by a circular ring (like a key ring). This can be pulled to release the pressure in the keg. Two metal tubes are attached to the ports on the inside of the keg. The “gas-in” port has a short tube, not reaching the fluid. The “liquid-out” port has a long tube (a “dip tube”) which reaches to the bottom of the keg. When pressurized gas (usually carbon dioxide and sometimes a blend of carbon dioxide and nitrogen) is forced into the “gas-in” port, it pushes the drink from the bottom of the keg, out of the “liquid-out” port, presumably to a tap.

The connectors which attach to the ports of the Cornelius keg come in two varieties: pin-lock and ball-lock, and they are not interchangeable. On a pin-lock keg, there are metal posts (pins) extending horizontally from around the port. When the connector is attached, these pins hold it in place. The “gas-in” port has two pins, while the “liquid-out” has three, making it impossible to accidentally attach the hoses backwards (which would result in carbon dioxide bubbling up through the drink, but no drink being dispensed). Ball-lock kegs have ridges in the ports, which are gripped by small metal balls in the connectors. Both types of kegs are fairly common, though ball-lock seem to be more common.

Ball lock type quick disconnects seem to be the most popular way to connect both gas and liquid lines to the Cornelius keg for home beer brew dispensing. A typical beer line to control foaming has a 3/16th internal diameter giving it a resistance of 2 psi per foot. It's common to serve at pressures between 9 and 11 psi.

Cornelius kegs are most commonly used by home beer brewers as an alternative to bottling their beer, as these kegs are easier to fill, clean and maintain than industry-standard beer kegs. In addition to this, most home brewers must bottle their beer by hand, which can be a tedious chore for large batches of beer. Conveniently, the most common size of Cornelius keg holds five US gallons of liquid, which is a typical batch size of home brewed beer. Other home beer batch sizes such as one, or three US gallons of liquid are available as well although they are much less common. This means that rather than saving, cleaning, and filling perhaps fifty individual bottles of beer, the brewer only needs to fill one five gallon keg.

Patents disclosing subject matter generally related to the present invention include: U.S. Pat. No. 4,754,698 issued to Ralph Naish on Jul. 5, 1988; U.S. Pat. No. 6,032,571 issued to Brous et al. on Mar. 7, 2000; U.S. Pat. No. 7,810,679 issued to Wauters et al. on Oct. 12, 2010; and U.S. patent application No. 2009/0308992 published on Dec. 17, 2009.

### BRIEF SUMMARY OF EMBODIMENTS

There is a desire and a need for improvements in home beer brewing, particularly to provide a keg which is easy to clean, has interchangeable modular parts to accommodate different brew batch sizes, to allow hand assembly of pieces not requiring any special tools, and to be flexible for use in fermenting, carbonating, storing and dispensing beer or wort.

The above and other aspects of various embodiments of the present invention will become apparent in view of the following description, claims and drawing.

A beer brewing and dispensing apparatus for home beer brewing, storage and dispensing includes: one or more interchangeable keg bodies of different volumes for fermenting, carbonating, storing and dispensing beer or wort; a keg top having one or more pipe connectors, the keg top fastened to a top section of a selected one of the keg bodies using a top gasket and a top clamp, the top gasket providing an air tight seal between the keg top and the selected keg body; and a keg bottom fastened to a bottom section of the selected keg body using a bottom gasket and a bottom clamp, the bottom gasket providing an air tight seal between the keg bottom and the selected keg body, wherein the assembled beer brewing apparatus is capable of storing beer or wort at a minimum pressure of 40 psi.

Each of the one or more interchangeable keg bodies is a stainless steel cylindrical sleeve and each of the one or more interchangeable keg bodies includes a top flange at the top section and a bottom flange at the bottom section, the top flange facilitating the air tight seal between the keg top and the selected keg body in cooperation with the top gasket and the top clamp, and the bottom flange facilitating the air tight seal between the keg bottom and the selected keg body in cooperation with the bottom gasket and the bottom clamp.

### BRIEF DESCRIPTION OF THE DRAWINGS

FIG. 1 is a front perspective view of a first embodiment of a beer brewing apparatus according to the principles of the invention;

FIG. 2 is a front perspective view of a second embodiment of a beer brewing apparatus according to the principles of the invention;

FIG. 3 is a front perspective view of a third embodiment of a beer brewing apparatus according to the principles of the invention;

FIG. 4 is an exploded front perspective view of the beer brewing apparatus of FIG. 1;

FIG. 5A is a perspective view of an open band clamp used for securing portions of the beer brewing apparatus of FIG. 1; and

FIG. 5B is a perspective view of a closed band clamp used for securing portions of the beer brewing apparatus of FIG. 1.

### DETAILED DESCRIPTION

In the following description, specific details are set forth although it should be appreciated by one of ordinary skill that the systems and methods can be practiced without at least some of the details. In some instances, known features or processes are not described in detail so as not to obscure the present invention.

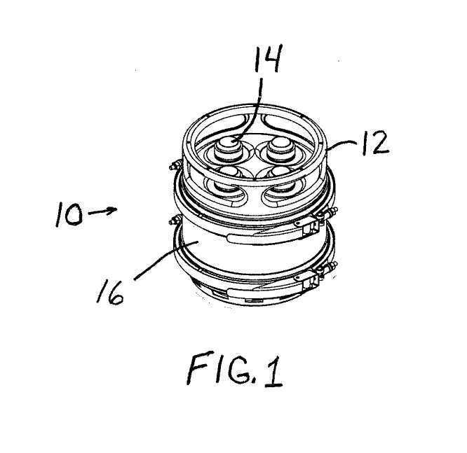

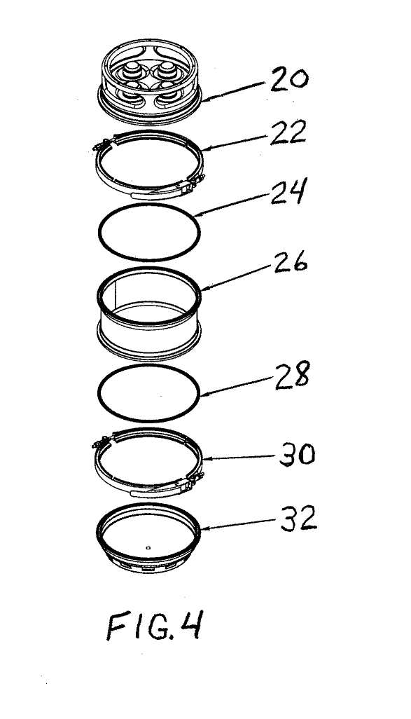

FIG. 1 is a front perspective view of a beer brewing apparatus 10 which holds a brew batch volume of about 1.1 gallons of beer or wort. This is a mini-keg used for home beer brewing. The components of the keg 10 are shown in FIG. 4 to include: a keg top 20; a 1.1 gallon keg body 26; a keg bottom 32; a top clamp 22; a bottom clamp 30; a top gasket 24 and a bottom gasket 28.

The keg top 20, keg body 26, keg bottom 32, top clamp 22 and bottom clamp 30 are all preferably constructed of stainless steel or any other material which is acceptable for housing beer and which can withstand the pressures involved in home beer brewing, typically up to 40 psi. The top and bottom gaskets 24, 28 are preferably silicone beaded gaskets.

Each of the keg top 20, the keg body 26 and the keg bottom 32 preferably have machined flanges or beveled surfaces which will engage with other components during assembly in order to facilitate attachment between the components and strengthen the overall assembly while being air tight. The keg body 26 also preferably has machined flanges on both ends for assisting in connecting and mating the keg body 26 with both the keg top 20 and the keg bottom 26.

The keg top 20, also referred to as a lid, includes a formed handle 12 and one or more pipe connectors 14 which are formed into the keg top. Each of the one or more pipe connectors 14 is cylindrical in shape and includes a central opening surrounded by a circular wall component having external screw threads. The pipe connectors and their corresponding openings can be of any size or dimension so long as they are compatible with external hoses and/or other components that are useful for home brewing, storage and dispensing. The opening of the pipe connector 14 in one embodiment has a 29 mm diameter.

Various beer brewing or dispensing components can be connected to the keg 10 via one of the pipe connectors 14 such as: a ball lock connector for dispensing beer; a ball lock connection for inserting gases; a pressure release valve for releasing gases from the keg; a cap closure with a hook for hanging a hop bag; a thermowell; heating and chilling elements to warm or cool the beer or wort, respectively; a bung with an airlock to release fermentation gases; a siphoning device to transfer the beer or wort from the keg to another container; and a blow off assembly for allowing gases and krausen to escape from the beer brewing apparatus during fermentation. The pipe connections have been designed without gaskets for easier cleaning They have also been designed without internal threads for easier cleaning and to keep all internal surfaces smooth for easier cleaning.

The above is a partial list of components which can be connected to the keg 10 via one of the pipe connectors 14. Some components for connection to the keg 10 such as, but not limited to, a bung, cap or hose can be screwed onto the external screw threads of one of the pipe connectors 14. Any other components or devices useful in beer brewing, storage and dispensing but not listed above can be connected as well.

The thermowell is a tubular fitting used to protect temperature sensors installed into the beer brewing or dispensing apparatus. It consists of a tube closed at one end and mounted in the process stream. A temperature sensor such as a thermometer, thermocouple or resistance temperature detector is inserted in the open end of the tube, which is usually in the open air outside the process piping or keg and any thermal insulation. The beer or wort transfers heat to the thermowell wall, which in turn transfers heat to the sensor.

The temperature sensor is inserted into the open end of the thermowell; thermodynamically, the process fluid transfers heat to the thermowell wall, which in turn transfer heat to the sensor. To be representative of the average temperature of beer or wort, the thermowell must extend a few percent of the inside diameter of the process pipe or keg.

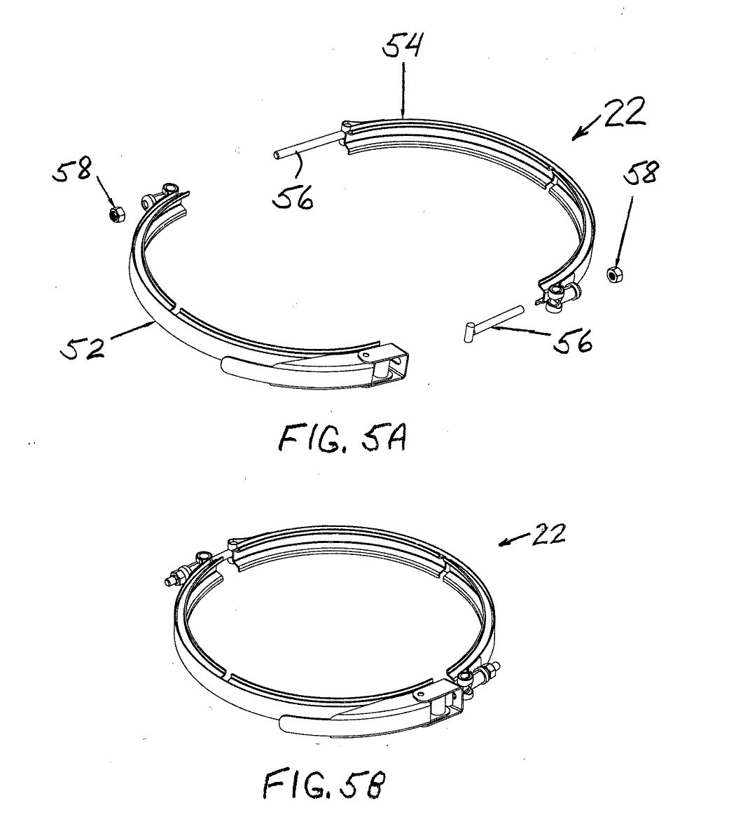

The band clamp 22 of FIG. 4 is shown in more detail in FIGS. 5A and 5B. Preferably the top band clamp 22 and the bottom band clamp 30 are identical and interchangeable. FIG. 5A is a perspective view of an open band clamp 22 used for securing portions of the beer brewing apparatus 10 of FIG. 1. A closed band clamp 22 is shown in FIG. 5B. The band clamp 22 includes a left V-band 54 and a right V-band 52 which are drawn together and connected via tee nuts 56 and lock nuts 58.

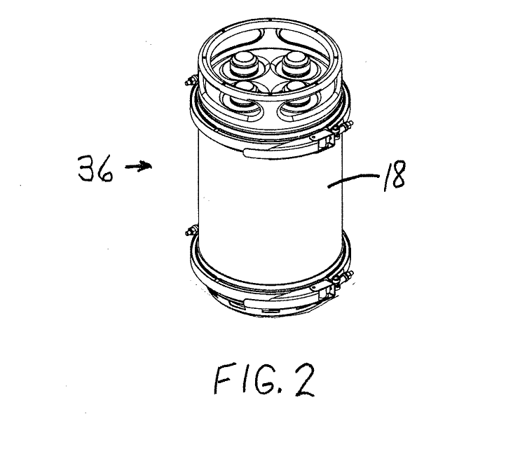

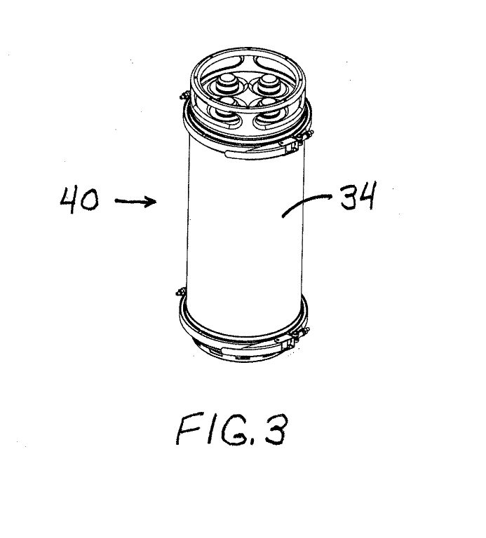

The current invention provides home beer brewers with component modularity and interchangeability to easily convert keg sizes and volumes. The inventive beer brewing apparatus provides variable keg sizes such as, but not limited to, the 1.1 gallon keg or device 10 of FIG. 1, the 3.1 gallon keg/device 36 of FIG. 2 and the 5.1 gallon keg/device 40 of FIG. 3. All of the components of the 1.1 gallon keg/device 10, also referred to as the beer brewing apparatus 10, as described above and shown in FIG. 4 are identical for the 3.1 gallon keg/device 36 and the 5.1 gallon keg/device 40 except for the keg bodies which will vary. Each of the keg bodies 16, 18 and 34 are preferably stainless steel cylinders having flanged top and bottom edges and holding different volumes of liquid.

When assembling the apparatuses 10, 36 or 40 which can be used for beer brewing, storage and dispensing, the user matches the brew size that he or she plans to brew with an appropriate keg body since all the components are interchangeable. For example, if the home brewer wishes to brew about 1.1 gallons of his favorite beer, he would assemble an apparatus 10 from the parts list of FIG. 4 which would be a 1.1 gallon keg/device 10 as shown in FIG. 1. If the brewer wishes to brew about 3.1 gallons, he would assemble an apparatus 36 using the same parts of FIG. 4 but would exchange the 1.1 gallon keg body with the 3.1 keg body 18 of FIG. 2. To brew about 5.1 gallons, he would assemble an apparatus 40 using the same parts of FIG. 4 but would exchange the 1.1 gallon keg body with the 5.1 keg body 34 of FIG. 3. Of course, any other desirable keg body size could be used as well.

Each of the components or parts of the beer brewing apparatus are interchangeable between different keg sizes. Also the cylindrical shape of the apparatus allows use of identical top and bottom clamps 22, 30, and identical top and bottom gaskets 24 and 28. Hand assembly or dis-assembly is easy without the need for any tools whatsoever since each of the parts can be adequately hand tightened with the gaskets to provide an air-tight seal.

To assemble the beer brewing apparatus the user would first select the desired keg body size, for example the 5 gallon size of FIG. 3, then place the bottom gasket seal 28 between the keg bottom 32 and the 5 gallon keg body 34 and fasten the parts together with the bottom clamp 30. Next the user would place the top gasket seal 24 between the top of the keg body 34 and the keg top 20 and fasten them together with the top clamp 22. The order of assembly is inconsequential.

Cleaning for the beer brewing apparatus 10 is simplified since the keg top 20 (or the keg bottom 32) can be completely removed by hand and then the interior of the keg can be easily hand cleaned. Alternatively, the whole apparatus can be easily and quickly dis-assembled by hand and each part cleaned separately. A single beer brewing assembly can be used with interchangeable keg bodies to save space and equipment expense.

While the invention has been shown and described with reference to specific embodiments, it should be understood by those skilled in the art that various changes in form and detail may be made therein without departing from the spirit and scope of the invention.

What is claimed is:

1. A beer brewing and dispensing apparatus for home beer brewing, storage and dispensing, comprising:
one or more interchangeable keg bodies of different volumes for fermenting, carbonating, storing and dispensing beer or wort;
a keg top comprising one or more pipe connectors, the keg top fastened to a top section of a selected one of the keg bodies using a top gasket and a top clamp, said top gasket providing an air tight seal between the keg top and the selected keg body; and
a keg bottom fastened to a bottom section of the selected keg body using a bottom gasket and a bottom clamp, said bottom gasket providing an air tight seal between the keg bottom and the selected keg body,
wherein the assembled beer brewing apparatus is capable of storing beer or wort at a minimum pressure of 40 psi.

2. The beer brewing and dispensing apparatus of claim 1, wherein the one or more interchangeable keg bodies comprise a keg body having a volume of about 1.1 gallons, a keg body having a volume of about 3.1 gallons and a keg body having a volume of about 5.1 gallons.

3. The beer brewing and dispensing apparatus of claim 1, wherein the one or more interchangeable keg bodies comprise stainless steel cylinders, the keg top is manufactured from stainless steel and the keg bottom is manufactured from stainless steel.

4. The beer brewing and dispensing apparatus of claim 1, wherein the top and bottom gaskets are silicone beaded gaskets, and the top and bottom clamps are band clamps.

5. The beer brewing and dispensing apparatus of claim 1, wherein each of the one or more interchangeable keg bodies comprises a top flange at the top section and a bottom flange at the bottom section, said top flange facilitating the air tight seal between the keg top and the selected keg body in cooperation with the top gasket and the top clamp, and said bottom flange facilitating the air tight seal between the keg bottom and the selected keg body in cooperation with the bottom gasket and the bottom clamp.

6. The beer brewing and dispensing apparatus of claim 1, wherein the keg top further comprises a handle.

7. The beer brewing and dispensing apparatus of claim 1, wherein each of the one or more pipe connectors comprises an opening surrounded by a circular component with external screw threads.

8. The beer brewing and dispensing apparatus of claim 7, wherein the opening comprises a 29 mm diameter.

9. The beer brewing and dispensing apparatus of claim 1, wherein each of the one or more pipe connectors is available for connection via hand tightening without tools to one of: a ball lock connector for dispensing beer from the apparatus; a ball lock connector for inserting carbonating gases into the apparatus; a pressure release valve for releasing gases from the apparatus; a cap closure; a thermowell; a port for heating and chilling elements to warm or cool the beer or wort, respectively; a bung with an airlock to release gas during fermentation; a siphoning device to transfer the beer or wort to another container; and a blow off assembly for allowing gases to escape from the apparatus during fermentation.

10. The beer brewing and dispensing apparatus of claim 9, wherein the cap closure comprises a hook for hanging a hop bag

11. The beer brewing and dispensing apparatus of claim 1, wherein the keg bottom is dish shaped or cone shaped for collecting trub or yeast.

12. An apparatus for home beer brewing, storage and dispensing, comprising:
a top lid comprising one or more pipe connectors;
a keg bottom; and
a first cylindrical sleeve having a first cylindrical length, defining a first volume and having a first top flanged section and a first bottom flanged section, the first cylindrical sleeve connected along the first bottom flanged section to the keg bottom via a bottom gasket and a bottom band clamp to create an air tight seal between the first cylindrical sleeve and the keg bottom, the first cylindrical sleeve connected along the first top flanged section to the top lid via a top gasket and a top band clamp to create an air tight seal between the first cylindrical sleeve and the top lid,
wherein the first cylindrical sleeve is interchangeable with a second cylindrical sleeve having a second cylindrical length different from the first cylindrical length, a second top flanged section and a second bottom flanged section, and defining a second volume different from the first volume,
wherein the assembled apparatus is capable of storing beer or wort at a minimum pressure of 40 psi.

13. The apparatus of claim 12, wherein each of the first and second volumes equals about 1.1 gallons, about 3.1 gallons or about 5.1 gallons.

14. The apparatus of claim 12, wherein the top lid, the keg bottom, the first cylindrical sleeve and the second cylindrical sleeve are manufactured from stainless steel.

15. The apparatus of claim 12, wherein the top and bottom gaskets are silicone beaded gaskets, and the top and bottom clamps are band clamps.

16. The apparatus of claim 12, wherein the top lid further comprises a handle.

17. The apparatus of claim 12, wherein each of the one or more pipe connectors comprises an opening surrounded by a circular component with external screw threads.

18. The beer brewing apparatus of claim 17, wherein the opening comprises a 29 mm diameter.

19. The beer brewing apparatus of claim 12, wherein each of the one or more pipe connectors is available for connection via hand tightening without tools to one of: a ball lock connector for dispensing beer from the apparatus; a ball lock connector for inserting carbonating gases into the apparatus; a pressure release valve for releasing gases from the apparatus; a cap closure; a thermowell; a port for heating and chilling elements to warm or cool the beer or wort, respectively; a bung with an airlock to release gas and lower gas pressure when gas within the apparatus reaches a predetermined threshold; a siphoning device to transfer the beer or wort to another container; and a blow off assembly for allowing gases to escape the apparatus during fermentation.

20. The beer brewing apparatus of claim 19, wherein the cap closure comprises a hook for hanging a hop bag.
